(19) United States
(12) Patent Application Publication
(10) Pub. No.: US 2025/0378789 A1
(43) Pub. Date: Dec. 11, 2025

(54) DISPLAY DEVICE AND REFRESH DRIVING METHOD

(71) Applicant: BOE TECHNOLOGY GROUP CO., LTD., Beijing (CN)

(72) Inventors: Guangliang Shang, Beijing (CN); Shiming Shi, Beijing (CN); Libin Liu, Beijing (CN); Xinbin Han, Beijing (CN); Lang Liu, Beijing (CN)

(73) Assignee: BOE TECHNOLOGY GROUP CO., LTD., Beijing (CN)

(21) Appl. No.: 18/702,984

(22) PCT Filed: Aug. 9, 2023
(86) PCT No.: PCT/CN2023/111902

§ 371 Date: Apr. 19, 2024

(30) Foreign Application Priority Data
Aug. 29, 2022 (CN) 202211040233.5

(51) Int. Cl. G09G 3/3266

(52) U.S. Cl. CPC G09G 3/3266; G09G 2310/0245; G09G 2310/08; G09G 2320/0233; G09G 2320/0247; G09G 2330/021

(57) ABSTRACT

A display device and a refresh driving method are provided. The display device includes a display panel and a driving module; where the display panel includes a first display area, a second display area, and a plurality of rows and columns of pixel circuits; and the driving module is configured to control a refresh frequency of the pixel circuits provided in the first display area to be a first refresh frequency, and control a refresh frequency of the pixel circuits provided in the second display area to be different from the first refresh frequency.

### CROSS-REFERENCE TO RELATED APPLICATIONS

This application claims priority to Chinese Patent Application No. 202211040233.5 filed in China on Aug. 29, 2022, the entire contents of which are hereby incorporated by reference.

### TECHNICAL FIELD

The present disclosure relates to the technical field of display, and more particularly, to a display device and a refresh driving method.

### BACKGROUND

When the relevant OLED (organic light emitting diode) display screen works, when the display screen is updated, the full screen will be updated and the driving power consumption will be high.

### SUMMARY

In one aspect, embodiments of the present disclosure provide a display device including a display panel and a driving module; wherein the display panel includes a first display area, a second display area, and a plurality of rows and columns of pixel circuits; and

the driving module is configured to control a refresh frequency of the pixel circuits provided in the first display area to be a first refresh frequency, and control a refresh frequency of the pixel circuits provided in the second display area to be different from the first refresh frequency.

Optionally, the driving module is configured to, when it is determined that a picture displayed in a part of the display area included in the display panel changes and a picture displayed in the other part of the display area included in the display panel does not change, control a refresh frequency of the pixel circuits in the part of the display area to be a first refresh frequency, and control a refresh frequency of the other part of the display area to be less than the first refresh frequency; the part of the display area is an updated display area, and the other part of the display area is a non-updated display area; the updated display area is the first display area, and the non-updated display area is the second display area.

Optionally, the driving module is further configured to, when at least one row of pixel circuits is provided in the updated display area, adjust a refresh frequency of the at least one row of pixel circuits in the updated display area by controlling a frequency of a first start signal and a frequency of a second start signal.

Optionally, the driving module includes a first update GOA module and a second update GOA module;
the first update GOA module is configured to provide an N-type scanning signal for the at least one row of pixel circuits;
the second update GOA module is configured to provide a P-type scanning signal for the at least one row of pixel circuits;
the first update GOA module includes multiple stages of first update GOA circuits, and the second update GOA module includes a plurality of groups of second update GOA circuits;
a first-stage first update GOA circuit included in the first update GOA module is connected to the first start signal, and a first-stage second update GOA circuit included in the second update GOA module is connected to the second start signal.

Optionally, two adjacent pixel circuit groups adjacent to the at least one row of pixel circuits in the updated display area are provided in the non-updated display area; the adjacent pixel circuit group includes at least one row of transition pixel circuits; and
the driving module is configured to control a refresh frequency of the at least one row of transition pixel circuits to be a second refresh frequency, wherein the second refresh frequency is less than the first refresh frequency, and the second refresh frequency is greater than the refresh frequency of the other part of the display area.

Optionally, non-adjacent pixel circuit groups other than the adjacent pixel circuit groups are further provided in the non-updated display area; the non-adjacent pixel circuit group includes at least one row of pixel circuits; and
the driving module is configured to control a refresh frequency of pixel circuits included in the non-adjacent pixel circuit group to be a third refresh frequency; and the third refresh frequency is less than the second refresh frequency.

Optionally, when M rows and N columns of pixel circuits are provided in the updated display area, and N is less than a total number of columns of pixel circuits included in the display panel, the pixel circuit includes a writing control circuit; M and N are positive integers;
a control end of the writing control circuit is electrically connected to a writing control line, a first end of the writing control circuit is electrically connected to a data line, and a second end of the writing control circuit is electrically connected to a data writing node; the writing control circuit is configured to control connection between the data line and the data writing node under control of a writing control signal provided by the writing control line;
the driving module is configured to control a frequency of the writing control signal connected to the control end of the writing control circuit included in pixel circuits located in a same row but in different columns in the M rows and N columns of pixel circuits, so that a refresh frequency of the pixel circuits located in the same row but in different columns in the M rows and N columns of pixel circuits is less than the first refresh frequency.

Optionally, the driving module is further configured to control the frequency of a writing control signal connected to the control end of the writing control circuit included in the M rows and N columns of pixel circuits so that the refresh frequency of the M rows and N columns of pixel circuits is the first refresh frequency.

In a second aspect, embodiments of the present disclosure provide a refresh driving method applied to a display device, wherein the display device includes a display panel and a driving module; the display panel includes a first display area, a second display area, and a plurality of rows and columns of pixel circuits; the refresh driving method including:
controlling, by the driving module, a refresh frequency of the pixel circuits provided in the first display area to be a first refresh frequency, and controlling, by the driving module, a refresh frequency of the pixel circuits provided in the second display area to be different from the first refresh frequency.

Optionally, the refresh driving method of at least one embodiment of the present disclosure includes:
when it is determined that a picture displayed in a part of the display area included in the display panel changes and a picture displayed in the other part of the display area included in the display panel does not change, controlling a refresh frequency of the pixel circuits in the part of the display area to be a first refresh frequency, and controlling a refresh frequency of the other part of the display area to be less than the first refresh frequency; wherein
the part of the display area is an updated display area, and the other part of the display area is a non-updated display area; the updated display area is the first display area, and the non-updated display area is the second display area.

Optionally, the refresh driving method of at least one embodiment of the present disclosure includes: when at least one row of pixel circuits is provided in the updated display area, adjusting a refresh frequency of the at least one row of pixel circuits in the updated display area by controlling a frequency of a first start signal and a frequency of a second start signal.

Optionally, the display panel further includes a first update GOA module and a second update GOA module, the first update GOA module is configured to provide an N-type scanning signal for the at least one row of pixel circuits, and the second update GOA module is configured to provide a P-type scanning signal for the at least one row of pixel circuits; the first update GOA module includes multiple stages of first update GOA circuits, and the second update GOA module includes a plurality of groups of second update GOA circuits; a first-stage first update GOA circuit included in the first update GOA module is connected to the first start signal, and a first-stage second update GOA circuit included in the second update GOA module is connected to the second start signal.

Optionally, two adjacent pixel circuit groups adjacent to the at least one row of pixel circuits in the updated display area are provided in the non-updated display area; the adjacent pixel circuit group includes at least one row of transition pixel circuits; and
the refresh driving method further includes: controlling a refresh frequency of the at least one row of transition pixel circuits to be a second refresh frequency, wherein the second refresh frequency is less than the first refresh frequency.

Optionally, non-adjacent pixel circuit groups other than the adjacent pixel circuit groups are further provided in the non-updated display area: the non-adjacent pixel circuit group includes non-adjacent pixel circuits; and
the refresh driving method further includes: controlling a refresh frequency of the non-adjacent pixel circuit to be a third refresh frequency; wherein the third refresh frequency is less than the second refresh frequency.

Optionally, when M rows and N columns of pixel circuits are provided in the updated display area, and N is less than a total number of columns of pixel circuits included in the display panel, the pixel circuit includes a writing control circuit; a control end of the writing control circuit is electrically connected to a writing control line, a first end of the writing control circuit is electrically connected to a data line, and a second end of the writing control circuit is electrically connected to a data writing node; the writing control circuit is configured to control connection between the data line and the data writing node under control of a writing control signal provided by the writing control line; M and N are positive integers; and the refresh driving method includes:
controlling a frequency of the writing control signal connected to the control end of the writing control circuit included in pixel circuits located in a same row but in different columns in the M rows and N columns of pixel circuits, so that a refresh frequency of the pixel circuits located in the same row but in different columns in the M rows and N columns of pixel circuits is less than the first refresh frequency.

Optionally, the refresh driving method of at least one embodiment of the present disclosure further includes:
controlling the frequency of a writing control signal connected to the control end of the writing control circuit included in the M rows and N columns of pixel circuits so that the refresh frequency of the M rows and N columns of pixel circuits is the first refresh frequency.

### BRIEF DESCRIPTION OF THE DRAWINGS

FIG. 1 is a schematic illustration of a partition of a display panel of a display device according to the present disclosure;

FIG. 2 is a structure diagram of at least one embodiment of a display device according to the present disclosure;

FIG. 3 is operational timing diagram of at least one embodiment of the display device shown in FIG. 2;

FIG. 4 is a structure diagram of at least one embodiment of a display device according to the present disclosure;

FIG. 5 is operational timing diagram of at least one embodiment of the display device shown in FIG. 4;

FIG. 6 is a schematic illustration of a partition of a display panel of a display device according to the present disclosure;

FIG. 7 is another operational timing diagram of at least one embodiment of the display device shown in FIG. 4;

FIG. 8 is a circuit diagram of at least one embodiment of a pixel circuit in a display device according to the present disclosure;

FIG. 9 is a circuit diagram of at least one embodiment of the pixel circuit;

FIG. 10 is a sectional view of the display panel;

FIG. 11 is a circuit diagram of at least one embodiment of a first GOA circuit in a display device according to the present disclosure; and

FIG. 12 is a circuit diagram of at least one embodiment of a second GOA circuit in a display device according to the present disclosure.

### DETAILED DESCRIPTION

The embodiments of the present disclosure will now be described more fully hereinafter with reference to the accompanying drawings, in which some, but not all embodiments of the disclosure are shown. Based on the embodiments in the present disclosure, all other embodiments obtained by a person of ordinary skill in the art without inventive effort fall within the scope of the present disclosure.

The display device according to an embodiment of the present disclosure includes a display panel and a driving module; wherein the display panel includes a first display area, a second display area, and a plurality of rows and columns of pixel circuits; and
the driving module is configured to control a refresh frequency of the pixel circuits provided in the first display area to be a first refresh frequency, and control a refresh frequency of the pixel circuits provided in the second display area to be different from the first refresh frequency.

The display device according to an embodiment of the present disclosure may set a corresponding refresh frequency for different display areas to be able to reduce power consumption while normally displaying a picture.

In particular implementations, at least one row and at least one column of pixel circuits is provided in the first display area and at least one row and at least one column of pixel circuits is provided in the second display area.

A display device according to an embodiment of the present disclosure includes a display panel and a driving module;
the display panel includes a plurality of rows and columns of pixel circuits;
the driving module is configured to, when it is determined that a picture displayed in a part of the display area included in the display panel changes and a picture displayed in the other part of the display area included in the display panel does not change, control a refresh frequency of the pixel circuits in the part of the display area to be a first refresh frequency, and control a refresh frequency of the other part of the display area to be less than the first refresh frequency;
the part of the display area is an updated display area, and the other part of the display area is a non-updated display area; the updated display area is the first display area, and the non-updated display area is the second display area.

It will be appreciated that in this patent the updated display area is relative to the non-updated display area, for example: the non-updated display region refers to a display region having a lower update frequency, and the update frequency of the region is lower than that of the updated display region. For example: the update frequency of the non-updated display area is 30 HZ to 45 HZ lower than the update frequency of the updated display area; alternatively, without updating the display area, the human eye looks as if the picture does not change substantially or changes very slowly, e.g., 0 HZ to 30 HZ. (0 HZ may refer to picture still state).

In operation of the display device according to an embodiment of the present disclosure, when a driving module determines that a picture displayed in a part of a display area included in a display panel changes while a picture displayed in another part of the display area included in the display panel does not change, the driving module controls a refresh frequency of a pixel circuit in the display area where the picture is updated to be a first refresh frequency, and controls the refresh frequency of the pixel circuit in the display area where the picture is not updated to be less than the first refresh frequency, so that power consumption can be reduced while a picture is normally displayed.

When the relevant OLED (organic light emitting diode) display screen works, when the display screen is updated, the full screen will be updated and the driving power consumption will be high. If the display panel using low-frequency technology such as LTPO (low-temperature polycrystalline oxide) can keep the display brightness unchanged for a long time, the partial refresh driving method proposed in the embodiments of the present disclosure can be selected. When the partial refresh driving method proposed in the embodiment of the present disclosure updates the partial data of the display picture, the display panel also only refreshes the updated part of the picture data at a high frequency, and the other parts keep refreshing at a low frequency, thereby minimizing the driving power consumption.

In at least one embodiment of the present disclosure, the driving module is further configured to, when at least one row of pixel circuits is provided in the updated display area, adjust a refresh frequency of the at least one row of pixel circuits in the updated display area by controlling a frequency of a first start signal and a frequency of a second start signal.

In particular implementations, the driving module may adjust the refresh frequency of the pixel circuits in the updated display area by controlling the frequency of the first start signal and the frequency of the second start signal.

Optionally, the driving module includes a first update GOA (Gate on Array) module and a second update GOA module;
the first update GOA module is configured to provide an N-type scanning signal for the at least one row of pixel circuits;
the second update GOA module is configured to provide a P-type scanning signal for the at least one row of pixel circuits;
the first update GOA module includes multiple stages of first update GOA circuits, and the second update GOA module includes a plurality of groups of second update GOA circuits;
a first-stage first update GOA circuit included in the first update GOA module is connected to the first start signal, and a first-stage second update GOA circuit included in the second update GOA module is connected to the second start signal.

In particular implementation, a first update GOA module is configured to provide an N-type scanning signal for updating a pixel circuit in a display area, a second update GOA module is configured to provide a P-type scanning signal for updating the pixel circuit in the display area, and the driving module may further include a driving control unit, and at least one embodiment of the present disclosure may control a first start signal connected to the first-stage first update GOA circuit and a second start signal connected to the first-stage second update GOA circuit via the driving control unit so as to control and adjust the refresh frequency of the pixel circuit in the updated display area.

In at least one embodiment of the present disclosure, two adjacent pixel circuit groups adjacent to the at least one row of pixel circuits in the updated display area are provided in the non-updated display area; the adjacent pixel circuit group includes at least one row of transition pixel circuits; and
the driving module is configured to control a refresh frequency of the at least one row of transition pixel circuits to be a second refresh frequency, wherein the second refresh frequency is less than the first refresh frequency, and the second refresh frequency is greater than the refresh frequency of the other part of the display area.

In specific implementation, the display area adjacent to the updated display area can be set as a transitional display area, and the refresh frequency of the transitional display area is a second refresh frequency, wherein the second refresh frequency is between the low-frequency refresh frequency and the first refresh frequency, so as to reduce the display difference, prevent the human eye from perceiving, and reduce the flicker and Mura (display unevenness) problem which may be caused by the display difference of the adjacent display area. Wherein the low-frequency display frequency is a refresh frequency of the other part of the display area.

Optionally, non-adjacent pixel circuit groups other than the adjacent pixel circuit groups are further provided in the non-updated display area; the non-adjacent pixel circuit group includes non-adjacent pixel circuits; and
the driving module is configured to control a refresh frequency of pixel circuits to be a third refresh frequency; and the third refresh frequency is less than the second refresh frequency.

In at least one embodiment of the present disclosure, the third refresh frequency is the low-frequency display frequency.

In at least one embodiment of the present disclosure, the third refresh frequency may be less than or equal to 60 Hz, for example, the third refresh frequency may be, but is not limited to, 1 Hz, 10 Hz, 20 Hz, 30 Hz, 40 Hz, or 60 Hz.

Optionally, when M rows and N columns of pixel circuits are provided in the updated display area, and N is less than a total number of columns of pixel circuits included in the display panel, the pixel circuit includes a writing control circuit; M and N are positive integers;
a control end of the writing control circuit is electrically connected to a writing control line, a first end of the writing control circuit is electrically connected to a data line, and a second end of the writing control circuit is electrically connected to a data writing node; the writing control circuit is configured to control connection between the data line and the data writing node under control of a writing control signal provided by the writing control line;
the driving module is configured to control a frequency of the writing control signal connected to the control end of the writing control circuit included in pixel circuits located in a same row but in different columns in the M rows and N columns of pixel circuits, so that a refresh frequency of the pixel circuits located in the same row but in different columns in the M rows and N columns of pixel circuits is less than the first refresh frequency.

In at least one embodiment of the present disclosure, when the number of columns of pixel circuits in the updated display area is less than the total number of columns of pixel circuits included in the display panel, the frequency of the writing control signal may be controlled to control the refresh frequency of pixel circuits located in a same row but in different columns in the M rows and N columns of pixel circuits to be less than the first refresh frequency.

In at least one embodiment of the present disclosure, the driving module is further configured to control the frequency of a writing control signal connected to the control end of the writing control circuit included in the M rows and N columns of pixel circuits so that the refresh frequency of the M rows and N columns of pixel circuits is the first refresh frequency.

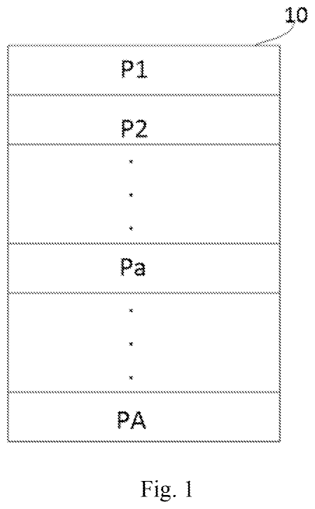

As shown in FIG. 1, the effective display area of the display panel 10 can be divided into A display areas;
in FIG. 1, a first preset display area with the reference numeral P1, a second preset display area with the reference numeral P2, an a-th preset display area with the reference numeral Pa, and an A-th preset display area with the reference numeral PA;
A is a positive integer and a is a positive integer less than A.

In actual operation, it is possible to automatically match a display area corresponding to the refresh according to the update condition of the display screen of the display panel, thereby minimizing power consumption. For example, when the display picture of the a-th preset display area Pa is updated and the display pictures of other display areas except the a-th preset display area Pa are not updated, the driving module controls the refresh frequency of the pixel circuit in the a-th preset display area Pa to be a first refresh frequency; the driving module controls the refresh frequency of the pixel circuit in the other display regions except the a-th preset display region Pa to be less than the first refresh frequency, for example, the first refresh frequency may be 120 Hz, and the refresh frequency of the pixel circuit in the other display regions except the a-th preset display region Pa may be 1 Hz; this is not a limitation.

In at least one embodiment of the present disclosure, the effective display area may be divided into A display areas on average; alternatively, the partitions may be non-equally divided according to display rules. For example, an office computer desktop task bar can be divided into one display area alone, a central display area when displaying a video can be divided into one display area alone, and a menu area and an editing area of a text office can be divided into one display area alone; the two-fold or multiple-fold areas of the foldable display panel can be divided into one display area respectively; and the like.

Furthermore, when a scene such as local video, icon flashing and text input appears in a certain display area on the display panel, a problem arises that the refresh frequency of the display area needs to be switched.

In particular implementation, the pixel circuit and the GOA circuit in the driving module can be partitioned while partitioning the display area;
When the effective display area is divided into A display areas, the driving module may include A first GOA modules and A second GOA modules; the a-th first GOA module corresponds to the a-th preset display area, and the a-th second GOA module corresponds to the a-th preset display area;
an a-th first GOA module is configured to provide a corresponding N-type scanning signal for a pixel circuit arranged in the a-th preset display area;
an a-th second GOA module is configured to provide a corresponding P-type scanning signal for a pixel circuit arranged in the a-th preset display area;
when the a-th preset display area is a refresh display area, the first update GOA module is the a-th first GOA module, and the second update GOA module is an a-th second GOA module.

In at least one embodiment of the present disclosure, when the effective display area is divided into A display areas, the driving module may include A first left-side GOA modules, A first right-side GOA modules, A second left-side GOA modules and A second right-side GOA modules;
an a-th first left-side GOA module and an a-th first right-side GOA module provide a corresponding N-type scanning signal for a pixel circuit arranged in the a-th preset display area;
an a-th second left-side GOA module and an a-th second right-side GOA module provide a corresponding P-type scanning signal for a pixel circuit arranged in the a-th preset display area;
when the a-th preset display area is a refresh display area, the first update GOA module includes the a-th first left-side GOA module and the a-th first right-side GOA module, and the second update GOA module includes the a-th second left-side GOA module and the a-th second right-side GOA module.

In at least one embodiment of the present disclosure, each GOA module may include at least one stage of GOA circuits cascaded with each other; A first GOA module may include at least one stage of first GOA circuits, and a second GOA module may include at least one stage of second GOA circuits;
one stage of first GOA circuit can provide a corresponding N-type scanning signal for two lines of pixel circuits, and one stage of second GOA circuit can provide a corresponding P-type scanning signal for one line of pixel circuits; this is not a limitation.

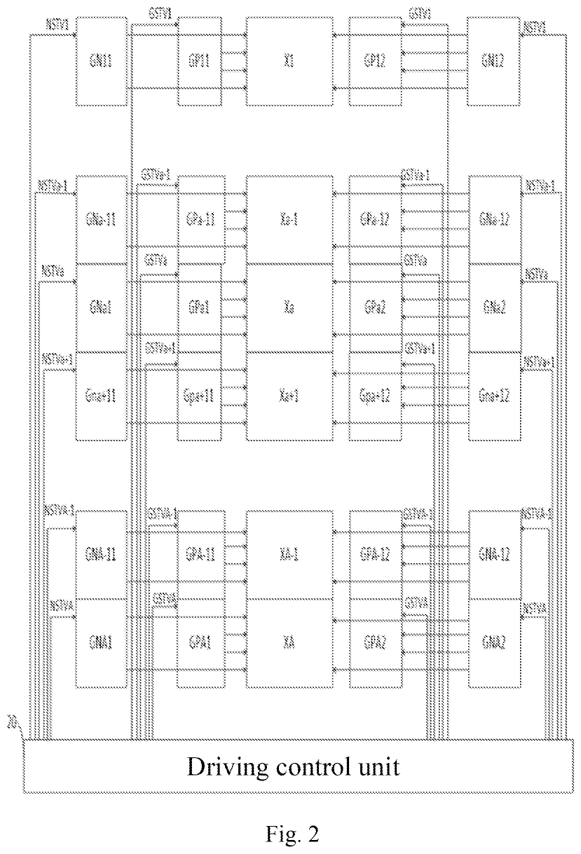

As shown in FIG. 2, the number X1 is all the row pixel circuits in the first preset display area; the number Xa−1 is all the row pixel circuits in the (a−1)th preset display area, the number Xa is all the row pixel circuits in the a-th preset display area, the number Xa+1 is all the row pixel circuits in the (a+1)th preset display area, the number XA−1 is all the row pixel circuits in the (A−1)th preset display area, and the number XA is all the row display circuits in the A-th preset display area;
The reference numeral GN11 is a first first left-side GOA module, the reference numeral GNa−11 is an (a−1)th first left-side GOA module, the reference numeral GNa1 is an a-th first left-side GOA module, the reference numeral GNa+11 is an (a+1)th first left-side GOA module, and the reference numeral GNA1 is an A-th left-side GOA module;
the reference numeral GN12 is a first first right-side GOA module, the reference numeral GNa−12 is an (a−1)th right-side GOA module, the reference numeral GNa2 is an a-th right-side GOA module, the reference numeral GNa+12 is an (a+1)th right-side GOA module, and the reference numeral GNA2 is an A-th right-side GOA module;
The reference numeral GP11 is a first second left-side GOA module, the reference numeral GPa−11 is an (a−1)th second left-side GOA module, the reference numeral GPa1 is an a-th second left-side GOA module, the reference numeral GPa+11 is an (a+1)th second left-side GOA module, and the reference numeral GPA1 is an A-th second left-side GOA module;
the reference numeral GP12 is a first second right-side GOA module, the reference numeral GPa−12 is an (a−1)th second right-side GOA module, the reference numeral GPa2 is an a-th second right-side GOA module, the reference numeral GPa+12 is an (a+1)th second right-side GOA module, and the reference numeral GPA2 is an A-th second right-side GOA module;
As shown in FIG. 2, the driving module may further include a driving control unit 20;
the driving control unit 20 is configured to provide the GN11 and the GN12 with a first first start signal NSTV1, provide the GNa−11 and the GNa−12 with an (a−1)th first start signal NSTVa−1, provide the GNa1 and the GNa2 with an a-th first start signal NSTVa, provide the GNa+11 and the GNa+12 with an (a+1)th first start signal NSTVa+1, and provide the GNA1 and the GNA2 with an A-th first start signal NSTVA:

the driving control unit 20 is configured to provide a first second start signal GSTV1 for GP11 and GP12, provide an (a−1)th second start signal GSTVa−1 for GPa−11 and GPa−12, provide an a-th second start signal GSTVa for GPa1 and GPa2, provide an (a+1)th second start signal GSTVa+1 for GPa+11 and GPa+12, and provide an A-th second start signal GSTVA for GPA1 and GPA2.

When the a-th preset display area is an updated display area, and other display areas included in the active display area are non-updated display areas, the refresh frequency of the pixel circuit located in the a-th preset display area can be increased by increasing the frequency of the NSTV2a−1, the frequency of the NSTV2a, the frequency of the GSTV2a−1 and the frequency of the GSTV2a.

In at least one embodiment of the present disclosure, for example, when the at least one embodiment of the pixel circuit shown in FIG. 8 is in operation, the gate electrode of the eighth transistor T8 included in the pixel circuit is electrically connected to the first scanning line GN, the gate electrode of the second transistor T2 included in the pixel circuit is electrically connected to the gate electrode of the fourth transistor included in the pixel circuit is electrically connected to the second scanning line GP, and thus the refresh frequency of the pixel circuit is related to the frequency of the first start signal connected to the first GOA module providing the first scanning signal and the frequency of the second start signal connected to the second GOA module providing the second scanning signal.

In specific implementation, the frequency of a first start signal connected to the first GOA module is the same as the frequency of a first scanning signal output by the first GOA module, and the frequency of a second start signal connected to the second GOA module is the same as, but not limited to, the frequency of a second scanning signal output by the second GOA module.

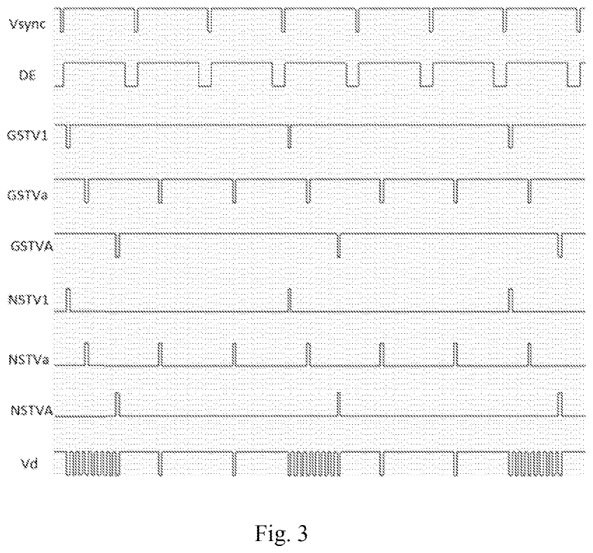

FIG. 3 is an operational timing diagram of at least one embodiment shown in FIG. 2.

In FIG. 3. Vsync is a synchronization signal. DE is a data enable signal, and Vd is a data voltage.

As shown in FIG. 3, the frequency of the NSTVa is greater than the frequency of the NSTV1, and the frequency of the NSTVa is greater than the frequency of the NSTVA; the frequency of GSTVa is greater than the frequency of GSTV1, and the frequency of GSTVa is greater than the frequency of GSTVA; so that the refresh frequency of the pixel circuit located in the a-th preset display area is greater than the refresh frequency of the pixels located in the other display areas.

In at least one embodiment of the present disclosure, when the refresh frequencies of the pixel circuits in the first display area are all 120 Hz, the frequencies of a first start signal connected to a first GOA module which provides a first scanning signal for the pixel circuits in the first display area and the frequencies of a second start signal connected to a second GOA module which provides a second scanning signal for the pixel circuits in the first display area may both be 120 Hz.

That is, when the refresh frequencies of the pixel circuits in the display area are all predetermined frequencies, the frequency of the first start signal connected to the first GOA module providing the first scanning signal for the pixel circuits in the first display area and the frequency of the second start signal connected to the second GOA module providing the second scanning signal for the pixel circuits in the first display area may both be the predetermined frequencies.

For example, when the ratio of the refresh frequency of the pixel circuit in the first display area to the refresh frequency of the pixel circuit in the second display area is 4, then the ratio of the frequency of the first start signal connected to the first GOA module which provides the first scanning signal for the pixel circuit in the first display area to the frequency of the first start signal connected to the first GOA module which provides the first scanning signal for the pixel circuit in the second display area may be 4, and the frequency of the second start signal connected to the second GOA module which provides the second scanning signal for the pixel circuit in the first display area. The ratio of the frequency of the second start signal to the second GOA module providing the second scanning signal to the pixel circuit in the second display area may be 4.

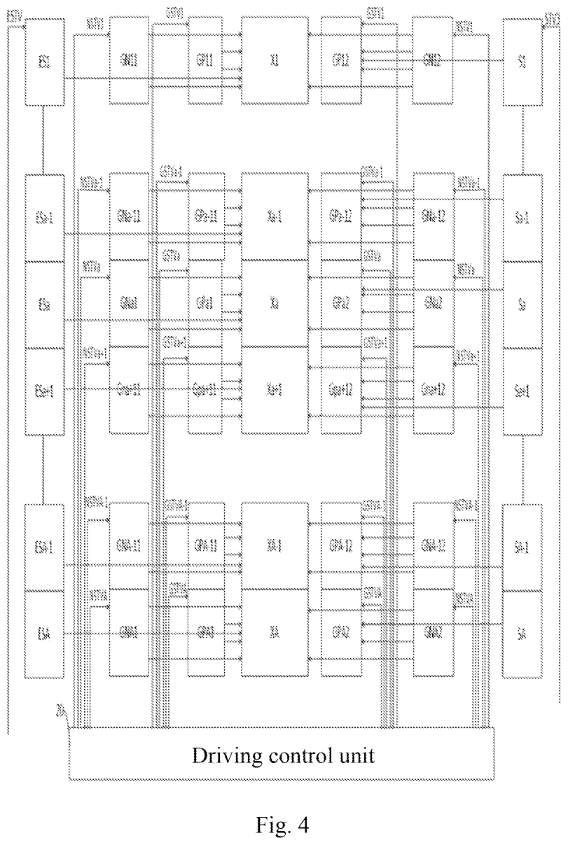

As shown in FIG. 4, on the basis of at least one embodiment of the display panel shown in FIG. 2, the driving module may further include A lighting control modules and A third GOA modules:
Reference sign ES1 is a first light-emitting control module, reference numeral ESa−1 is an (a−1)th light-emitting control module, reference numeral ESa is an a-th light-emitting control module, reference numeral ESa+1 is an (a+1)th light-emitting control module, and reference numeral ESA is an A-th light-emitting control module; each light emission control module is configured to provide a light emission control signal for a pixel circuit provided in a corresponding display area;
The reference numeral SI is a first third GOA module, the reference numeral Sa−1 is an (a−1)th third GOA module, the reference numeral Sa is an a-th third GOA module, the reference numeral Sa+1 is an (a+1)th third GOA module, and the reference numeral SA is an A-th third GOA module; each third GOA module is configured to provide a third scanning signal to a pixel circuit arranged in a corresponding display area.

As shown in FIG. 4. A light-emitting control modules included in the driving module can be cascaded with each other, and a first light-emitting control module is connected to a light-emitting control start signal ESTV;
a third GOA modules included in the driving module can be cascaded with each other, and a first third GOA module is connected to a third start signal STV3.

In particular implementations, the frequency of ESTV may be equal to the frequency of STV3, or the frequency of STV3 may be less than the frequency of ESTV.

In at least one embodiment of the present disclosure, the frequency of ESTV may be greater than or equal to 120 Hz and the frequency of STV3 may be greater than or equal to 120 Hz; for example, ESTV may have a frequency of 480 Hz and STV3 may have a frequency of 240 Hz, but this is not a limitation.

Optionally, the frequency of the data enable signal DE may be equal to, but not limited to, the maximum refresh frequency of the pixel circuits in the display areas included in the display panel.

In particular implementations, the frequency of Vd is related to the refresh frequency of the corresponding display area, the frequency of Vd being high when the refresh frequency corresponding to the pixel circuit in the currently scanned display area is high, and the frequency of Vd being low when the refresh frequency corresponding to the pixel circuit in the currently scanned display area is low.

In at least one embodiment of the present disclosure, light-emitting control modules corresponding to different preset display areas may respectively correspond to a light-emitting start signal, and at this time, light-emitting control modules corresponding to the same preset display area are cascaded with each other, and light-emitting control modules corresponding to different preset display areas are not cascaded with each other.

A third GOA module corresponding to each different preset display area may respectively correspond to a third start signal, and at this time, the third GOA modules corresponding to the same preset display area are cascaded with each other, and the third GOA modules corresponding to different preset display areas are not cascaded with each other.

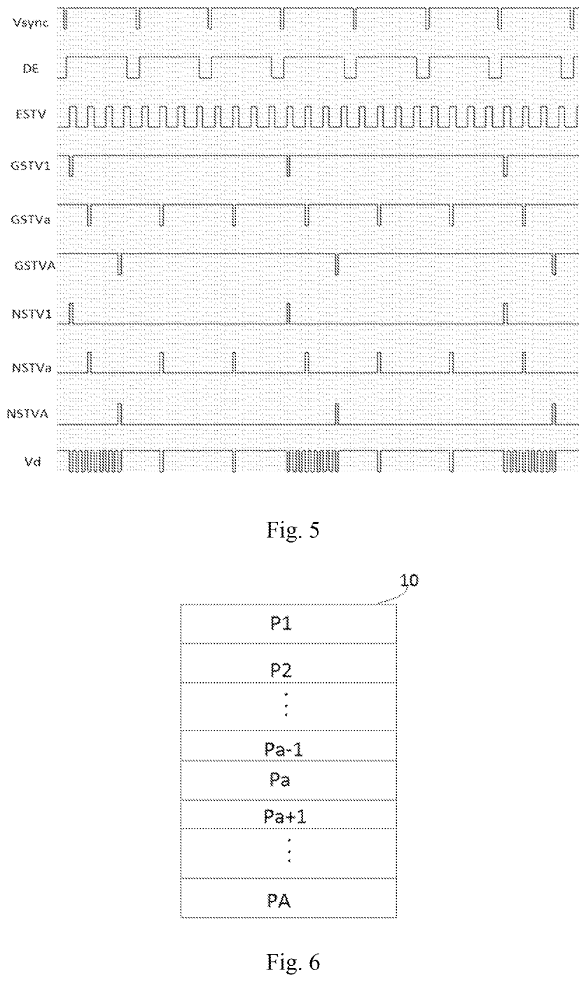

FIG. 5 is an operational timing diagram of at least one embodiment shown in FIG. 4.

FIG. 5 adds a light emission control start signal ESTV to the operation timing chart shown in FIG. 3, and ESTV is supplied to each light emission control module.

As shown in FIG. 5, the frequency of ESTV is high.

In at least one embodiment of the present disclosure, to address the problem of low frequency flicker, each lighting control module and each third GOA module perform a high frequency refresh.

As shown in FIG. 6, the effective display area of the display panel 10 can be divided into A display areas;
In FIG. 6, a first preset display area with the reference numeral P1, a second preset display area with the reference numeral P2, an (a−1)th preset display area with the reference numeral Pa−1, an a-th preset display area with the reference numeral Pa, an (a+1)th preset display area with the reference numeral Pa+1, and an A-th preset display area with the reference numeral PA;
A is a positive integer and a is a positive integer less than A.

In a specific implementation, the display panel may be divided into A display areas, and in order to reduce the flicker and Mura problem that may be caused by the difference between adjacent areas, updated display area may be used as a transition display area.

In at least one embodiment of the present disclosure, when the a-th preset display area Pa in FIG. 6 is an updated display area, the (a−1)th preset display area Pa−1 and the (a+1)th preset display area Pa+1 are transition display areas;
The driving module is configured to control the refresh frequency of the pixel circuit in Pa to be a first refresh frequency, controlling at least one of the refresh frequency of the pixel circuit in Pa−1 and the refresh frequency of the pixel circuit in Pa+1 to be a second refresh frequency, and controlling at least one of the refresh frequency of the pixel circuit in P1 and the refresh frequency of the pixel circuit in PA to be a third refresh frequency;
the first refresh frequency is greater than the second refresh frequency and the second refresh frequency is greater than the third refresh frequency.

In particular implementations, the first refresh frequency may be, for example, 120 Hz, the second refresh frequency may be, for example, 60 Hz, and the third refresh frequency may be, for example, 1 Hz, although this is not limiting.

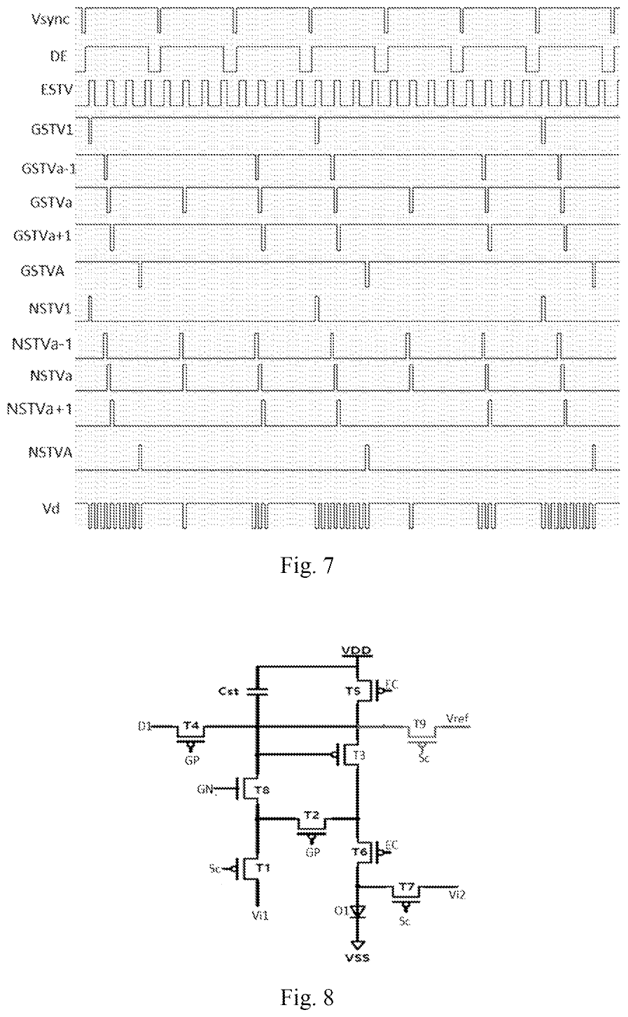

FIG. 7 is another operational timing diagram of at least one embodiment shown in FIG. 4.

In the specific implementation, when the a-th preset display area Pa is an updated display area and the (a−1)th preset display area Pa−1 and the (a+1)th preset display area Pa+1 are transition display areas, the waveforms of various start signals are as shown in FIG. 7.

In FIG. 7, the reference numeral Vsync is a synchronization signal, the reference numeral DE is a data enable signal, the reference numeral ESTV is a light-emitting control start signal, the reference numeral GSTV1 is a first second start signal, the reference numeral GSTVa−1 is an (a−1)th second start signal, the reference numeral GSTVa is an a-th second start signal, the reference numeral GSTVa+1 is an (a+1)th second start signal, the reference numeral GSTVA is an A-th second start signal, and the reference numeral NSTV1 is a first first start signal; is the (a−1)th first start signal labeled NSTVa−1, is the a-th first start signal labeled NSTVa, is the (a+1)th first start signal labeled NSTVa+1, is the A-th first start signal labeled NSTVA, and is the data voltage labeled Vd.

As shown in FIG. 7, the frequency of the GSTVa is greater than the frequency of the GSTVa−1, the frequency of the GSTVa is greater than the frequency of the GSTVa+1, the frequency of the GSTVa-I is greater than the frequency of the GSTV1, the frequency of the GSTVa−1 is greater than the frequency of the GSTVA, the frequency of the GSTVa+1 is greater than the frequency of the GSTV1, and the frequency of the GSTVa+1 is greater than the frequency of the GSTVA;
the frequency of NSTVa is greater than the frequency of NSTVa−1, the frequency of NSTVa is greater than the frequency of NSTVa+1, the frequency of NSTVa−1 is greater than the frequency of NSTV1, the frequency of NSTVa-I is greater than the frequency of NSTVA, the frequency of NSTVa+1 is greater than the frequency of NSTV1, and the frequency of NSTVa+1 is greater than the frequency of NSTVA.

As shown in FIG. 7, the frequency of ESTV is high.

In at least one embodiment of the present disclosure, to address the problem of low frequency flicker, each lighting control module and each third GOA module perform a high frequency refresh.

In at least one embodiment of the present disclosure, the pixel circuit may be configured as shown in FIG. 8.

As shown in FIG. 8, at least one embodiment of the pixel circuit may include a first transistor T1, a second transistor T2, a third transistor T3, a fourth transistor T4, a fifth transistor T5, a sixth transistor T6, a seventh transistor T7, an eighth transistor T8, a ninth transistor T9, a storage capacitor Cst and an organic light-emitting diode O1;
the gate electrode of the T8 is electrically connected to the first scanning line GN;
the gate electrode of T2 and the gate electrode of T4 are both electrically connected to the second scanning line GP;
the gate electrode of T1, the gate electrode of T7 and the gate electrode of T9 are all electrically connected to the third scanning line Sc;
the gate electrode of T5 and the gate electrode of T6 are both electrically connected to the light-emitting control line EC;
T3 is a driving transistor;
the first scanning line GN is configured to provide a first scanning signal, and the first scanning signal is an N-type scanning signal;
the second scanning line GP is configured to provide a second scanning signal, and the second scanning signal is a P-type scanning signal;
the third scanning line Sc is configured to provide a third scanning signal;
the light-emitting control line Sc is used to provide a light emission control signal.

In FIG. 8, reference numeral D1 is a data line, and the data line D1 is configured to provide a data voltage Vd; reference numeral Vi1 is a first initial voltage, reference numeral Vi2 is a second initial voltage, reference numeral Vref is a reference voltage, reference numeral VDD is a high voltage terminal, and reference numeral VSS is a low voltage terminal.

In at least one embodiment shown in FIGS. 8, T2 and T4 are p-type transistors, T8 is an n-type transistor, T1, T7 and T9 are p-type transistors, and T5 and T6 are p-type transistors.

In at least one embodiment of the present disclosure, the structure of the pixel circuit is not limited as shown in FIG. 8, and the pixel circuit can emit light under control of the first scanning signal, the second scanning signal, the third scanning signal, and the light emission control signal.

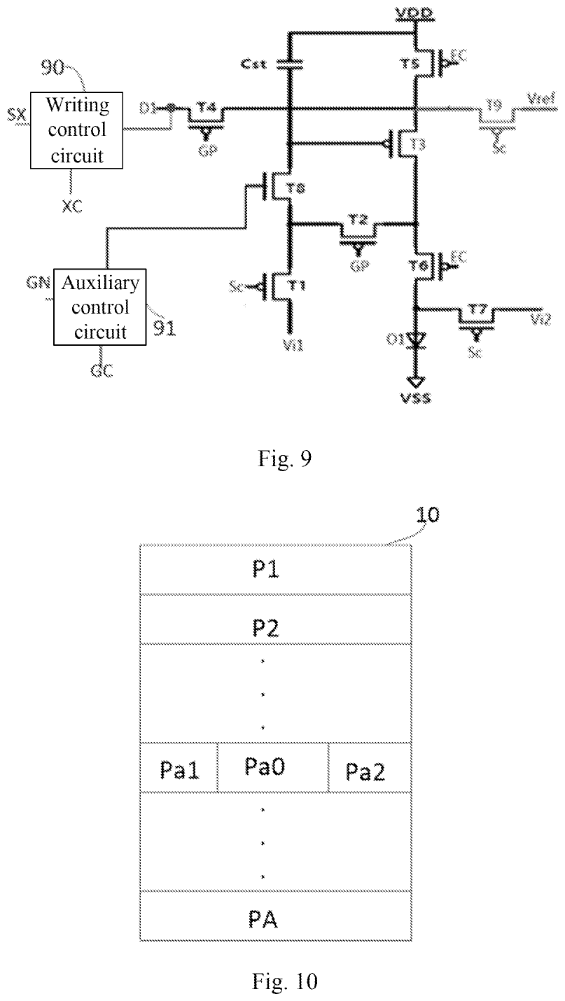

As shown in FIG. 9, based on the at least one embodiment of the pixel circuit shown in FIG. 8, the at least one embodiment of the pixel circuit may further include a writing control circuit 90;
a control end of the writing control circuit 90 is electrically connected to a writing control line XC, a first end of the writing control circuit 90 is electrically connected to a data line D1, and a second end of the writing control circuit 90 is electrically connected to a data writing node SX; the writing control circuit 90 is configured to control communication between the data line D1 and the data writing node SX under control of a writing control signal provided by the writing control line XC.

As shown in FIG. 9, based on the at least one embodiment of the pixel circuit shown in FIG. 8, the at least one embodiment of the pixel circuit may further include an auxiliary control circuit 91;
a control end of the auxiliary control circuit 91 is electrically connected to an auxiliary control line GC, a first end of the auxiliary control circuit 91 is electrically connected to a gate electrode of an eighth transistor T8, that is to say, a second end of the auxiliary control circuit 91 is connected to a first scanning line GN; the auxiliary control circuit 91 is configured to control connection between the first scanning line GN and the gate electrode of the eighth transistor T8 under control of an auxiliary control signal provided by the auxiliary control line GC.

In at least one embodiment shown in FIG. 9, the first scanning signal on the first scan line GN may be provided by a corresponding first GOA circuit included in the first GOA module.

For example: as shown in FIG. 10, when the active display area of the display panel includes a non-updated area Pa1 and an updated display area Pa0, an eighth transistor can be kept in an inactive state by controlling an auxiliary control line GC of an auxiliary control circuit 91 of a pixel circuit corresponding to the non-updated area Pa1 (for example: off state). This ensures that even if the other transistors of the pixel circuit of the non-updated area Pa1 is reset even if the other transistors of the pixel circuit of the non-updated area Pa1 operate. Meanwhile, the corresponding picture can be updated by controlling the auxiliary control line GC of the auxiliary control circuit 91 in the pixel circuit corresponding to the update region Pa0 so that the eighth transistor of the pixel circuit of the update region Pa0 maintains the normal operation state.

Optionally, both the writing control circuit 90 and the auxiliary control circuit 91 may be implemented using field effect transistors (for example, they may be of the same structure as other transistors of the pixel circuit and may be of P-type or N-type). This will not be repeated here. As shown in FIG. 10, the refresh display area included in the active display area of the display panel is a centrally located display area Pa0 included in the a-th preset display area;
the display area included in the a-th preset display area on the left side of the refresh display area As is designated as Pa1, and the display area included in the a-th preset display area on the right side of the refresh display area As is designated as Pa2.

In FIG. 10, a first preset display area is denoted by reference numeral P1, and an A-th preset display area is denoted by reference numeral PA.

When the refresh display area is a centrally located display area Pa0 included in the a-th preset display area, the structure of the pixel circuit in the a-th preset display area can be as shown in FIG. 9, and the pixel circuit includes a writing control circuit; when the display panel is in operation, the refresh frequency of the pixel circuit in Pa0 can be controlled to be a first frequency by controlling the frequency of the writing control signal, and the refresh frequency of the pixel circuit in Pa1 and the refresh frequency of the pixel circuit in Pa2 can be controlled to be less than the first frequency.

It will be appreciated that the writing control circuit 90 and the auxiliary control circuit 91 of FIG. 9 may be located in the display area of the display panel as well as in the non-display area of the display panel. For example: the writing control circuit 90 is integrated in the driving module or the writing control circuit 9 is integrated in the data signal drive chip.

It will be appreciated that in some embodiments, the driving module may control the update frequency of the pixel circuit to achieve lateral partitioning (e.g.: P1 . . . PA) by controlling the first update GOA module, the second update GOA module, etc. alone; longitudinal partitioning (e.g.: Pa1 . . . Pa2) through the auxiliary control circuit 91 and/or writing control circuit 90. Of course, the driving module can also combine the auxiliary control circuit 91 and/or the writing control circuit 90 to realize a horizontal and vertical hybrid partition (as shown in FIG. 10): for example: the driving module not only controls the update frequency of the pixel circuit by controlling the first update GOA module and the second update GOA module, etc. in combination with controlling the frequency of the writing control signal of the data line D1 of the pixel circuit by the writing control circuit 90 and controlling the operating frequency of the eighth transistor of the pixel circuit by the auxiliary control circuit 90, so as to realize horizontal and vertical hybrid partitioning (as shown in FIG. 10); of course, it is not limited thereto, but may be used in combination with other embodiments.

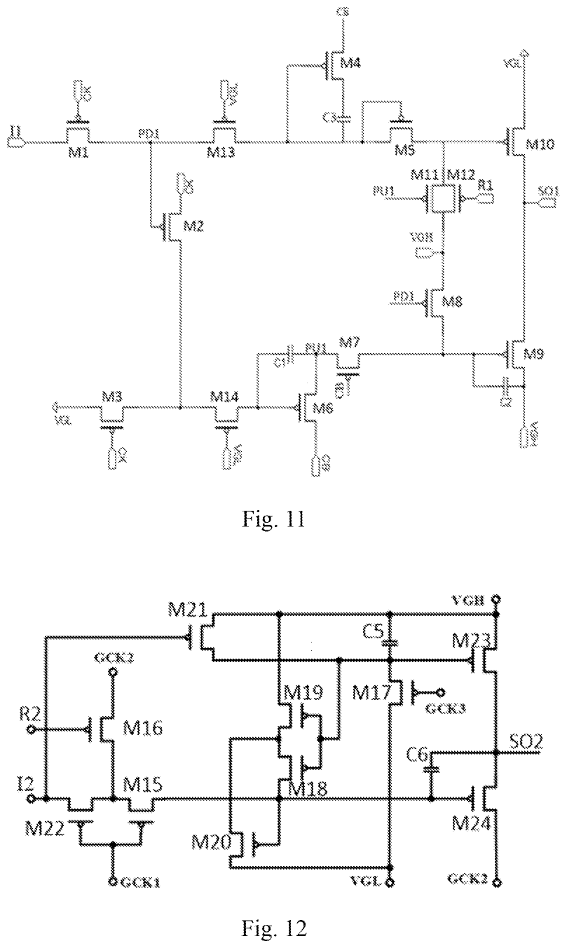

FIG. 11 is a circuit diagram of at least one embodiment of a first GOA circuit for providing an N-type scanning signal in at least one embodiment of the present disclosure.

As shown in FIG. 11, at least one embodiment of the first GOA circuit may include a first display control transistor M1, a second display control transistor M2, a third display control transistor M3, a fourth display control transistor M4, a fifth display control transistor M5, a sixth display control transistor M6, a seventh display control transistor M7, an eighth display control transistor M8, a ninth display control transistor M9, a tenth display control transistor M10, an eleventh display control transistor M11, and a twelfth display control transistor M12; A thirteenth display control transistor M13, a fourteenth display control transistor M14, a first capacitor C1, a second capacitor C2 and a third capacitor C3.

In FIG. 11, reference numeral CK is a first clock signal terminal, reference numeral I1 is a first input terminal, reference numeral CB is a second clock signal terminal, reference numeral VGL is a low voltage terminal, reference numeral VGH is a high voltage terminal, reference numeral PD1 is a first pull-down node, reference numeral PUI is a first pull-up node, reference numeral SO1 is a first scanning signal output terminal, and reference numeral R1 is a reset terminal.

In at least one embodiment of the first GOA circuit shown in FIG. 11, the second pole of M11 and the first pole of M8 may both be electrically connected to the high voltage terminal VGH.

In particular implementations, the first electrode may be a source or drain and the second electrode may be a drain or source.

When at least one embodiment of the first GOA circuit is configured to provide an N-type scanning signal, a first input terminal of a first stage first GOA circuit included in each first GOA module is connected to a first start signal. For example, a first first left-side GOA module and a first first right-side GOA module can both access a first first start signal, an (a−1)th first left-side GOA module and an (a−1)th first right-side GOA module can both access an (a−1)th first start signal, an a-th first left-side GOA module and an a-th first right-side GOA module can both access an a-th first start signal, an (a+1)th first left-side GOA module and an (a+1)th first right-side GOA module can both access an (a+1)th first start signal, both the A-th first left-side GOA module and the A-th first right-side GOA module can access the A-th first start signal.

At least one embodiment of the circuit shown in FIG. 11 can also be used to provide a light emission control signal, and in this case, the circuit can be a light emission control signal generation circuit included in each light emission control module; an input end of a first-stage light emission control signal generation circuit included in the first light emission control module can be accessed with a light emission control start signal.

At least one embodiment of the circuit shown in FIG. 11 can also be configured to provide a third scanning signal, and in this case, the circuit can be a third GOA circuit included in a third GOA module; the input end of the first stage third GOA circuit included in the first third GOA module is connected to the third start signal.

At least one embodiment of the circuit shown in FIG. 11 may be used to provide an N-type scanning signal, a light emission control signal, or a third scanning signal. When at least one embodiment of the circuit shown in FIG. 11 provides different signals, the first clock signal provided by the first clock signal terminal CK may be different from each other, and the second clock signal provided by the second clock signal terminal CB may be different from each other.

FIG. 12 is a circuit diagram of at least one embodiment of a second GOA circuit for providing a P-type scanning signal in at least one embodiment of the present disclosure.

As shown in FIG. 12, at least one embodiment of the second GOA circuit may include a fifteenth display control transistor M15, a sixteenth display control transistor M16, a seventeenth display control transistor M17, an eighteenth display control transistor M18, a nineteenth display control transistor M19, a twentieth display control transistor M20, a twenty-first display control transistor M21, a twenty-second display control transistor M22, a twenty-third display control transistor M23, a twenty-fourth display control transistor M24, a fourth capacitor C4, and a fifth capacitor C5.

In FIG. 12, reference numeral 12 is a second input end, reference numeral R2 is a second reset end, reference numeral VGL is a low voltage end, reference numeral VGH is a high voltage end, reference numeral SO2 is a second scanning signal output end, reference numeral GCK1 is a first output clock signal line, reference numeral GCK2 is a second output clock signal line, and reference numeral GCK3 is a third output clock signal line;
The second scanning signal output is for providing a second scanning signal.

In at least one embodiment of the present disclosure, a first output clock signal line GCK1 is used to provide a first output clock signal, a second output clock signal line GCK2 is used to provide a second output clock signal, and a third output clock signal line GCK3 is used to provide a third output clock signal.

When at least one embodiment of the second GOA circuit is configured to provide a P-type scanning signal, a second input terminal of a first stage second GOA circuit included in a second GOA module is connected to a second start signal.

In at least one embodiment of the present disclosure, at least one embodiment of the first GOA circuit may be used to provide an N-type scanning signal for the first scanning line GN, at least one embodiment of the second GOA circuit may be used to provide a P-type scanning signal for the second scanning line GP, at least one embodiment of the light emission control signal generation circuit may be used to provide a light emission control circuit for the light-emitting control line EC, and at least one embodiment of the third GOA circuit may be used to provide a third scanning signal for the third scanning line Sc.

The structure of at least one embodiment of the first GOA circuit, the structure of at least one embodiment of the light emission control signal generation circuit, and the structure of at least one embodiment of the third GOA circuit may be as shown in FIG. 11, and the structure of at least one embodiment of the second GOA circuit may be as shown in FIG. 12.

In operation of at least one embodiment of a display device as shown in FIG. 4 of the present disclosure, each first left-side GOA module and each first right-side GOA module may both provide an N-type scanning signal for a gate electrode of T8 in FIG. 8, each second left-side GOA circuit and each second right-side GOA circuit may both provide a P-type scanning signal for a gate electrode of T2 in FIG. 8 and a gate electrode of T4 in FIG. 8, each light emission control module may provide a light emission control signal for a gate electrode of T5 in FIG. 8 and a gate electrode of T6 in FIG. 8, and each third GOA module may provide a third scanning signal for a gate electrode of T7 in FIG. 8 and a gate electrode of T9 in FIG. 8; alternatively,
each first left-side GOA module and each first right-side GOA module may both provide an N-type scanning signal for the gate electrode of T8 in FIG. 8, each second left GOA circuit may be used to provide a P-type scanning signal for the gate electrode of T2 in FIG. 8, each second right GOA circuit may be used to provide a P-type scanning signal for the gate electrode of T4 in FIG. 8, each light emission control module may provide a light emission control signal for the gate electrode of T5 in FIG. 8 and the gate electrode of T6 in FIG. 8, and each third GOA module may provide a third scanning signal for the gate electrode of T7 in FIG. 8 and the gate electrode of T9 in FIG. 8.

The refresh driving method according to an embodiment of the present disclosure is applied to a display device, the display device including a display panel, the display panel including a plurality of rows and columns of pixel circuits, the refresh frequency method including:
when it is determined that a picture displayed in a part of the display area included in the display panel changes and a picture displayed in the other part of the display area included in the display panel does not change, controlling a refresh frequency of the pixel circuits in the part of the display area to be a first refresh frequency, and controlling a refresh frequency of the other part of the display area to be less than the first refresh frequency; wherein the part of the display area is an updated display area, and the other part of the display area is a non-updated display area.

In the refresh driving method according to an embodiment of the present disclosure, when a driving module determines that a picture displayed in a part of a display area included in a display panel changes while a picture displayed in another part of the display area included in the display panel does not change, the driving module controls a refresh frequency of a pixel circuit in the display area where the picture is updated to be a first refresh frequency, and controls the refresh frequency of the pixel circuit in the display area where the picture is not updated to be less than the first refresh frequency, so that power consumption can be reduced while a picture is normally displayed.

The refresh driving method of at least one embodiment of the present disclosure includes: when at least one row of pixel circuits is provided in the updated display area, adjusting a refresh frequency of the at least one row of pixel circuits in the updated display area by controlling a frequency of a first start signal and a frequency of a second start signal.

Optionally, the display panel further includes a first GOA module and a second GOA module, the first GOA module is configured to provide an N-type scanning signal for the at least one row of pixel circuits, and the second GOA module is configured to provide a P-type scanning signal for the at least one row of pixel circuits; the first GOA module includes multiple stages of first GOA circuits, and the second GOA module includes a plurality of groups of second GOA circuits; a first-stage first GOA circuit included in the first GOA module is connected to the first start signal, and a first-stage second GOA circuit included in the second GOA module is connected to the second start signal.

In at least one embodiment of the present disclosure, two adjacent pixel circuit groups adjacent to the at least one row of pixel circuits in the updated display area are provided in the non-updated display area; the adjacent pixel circuit group comprises at least one row of transition pixel circuits; and
the refresh driving method further includes: controlling a refresh frequency of the at least one row of transition pixel circuits to be a second refresh frequency, wherein the second refresh frequency is less than the first refresh frequency.

Optionally, non-adjacent pixel circuit groups other than the adjacent pixel circuit groups are further provided in the non-updated display area; the non-adjacent pixel circuit group includes non-adjacent pixel circuits; and
the refresh driving method further includes: controlling a refresh frequency of the non-adjacent pixel circuit to be a third refresh frequency; wherein the third refresh frequency is less than the second refresh frequency.

In at least one embodiment of the present disclosure, when M rows and N columns of pixel circuits are provided in the updated display area, and N is less than a total number of columns of pixel circuits included in the display panel, the pixel circuit includes a writing control circuit; a control end of the writing control circuit is electrically connected to a writing control line, a first end of the writing control circuit is electrically connected to a data line, and a second end of the writing control circuit is electrically connected to a data writing node; the writing control circuit is configured to control connection between the data line and the data writing node under control of a writing control signal provided by the writing control line; M and N are positive integers; and the refresh driving method includes:
controlling a frequency of the writing control signal connected to the control end of the writing control circuit included in pixel circuits located in a same row but in different columns in the M rows and N columns of pixel circuits to be less than the first refresh frequency.

The display device provided by the embodiments of the present disclosure may be a mobile phone, a tablet computer, a television, a display, a notebook computer, a digital photo frame, a navigator, or any product or component with display functions.

While the foregoing is directed to the preferred embodiments of the present disclosure, it will be understood by those skilled in the art that numerous modifications and adaptations may be made without departing from the principles of the disclosure, and such modifications and adaptations are intended to be within the scope of the disclosure.

1. A display device, comprising a display panel and a driving module; wherein
the display panel comprises a first display area, a second display area, and a plurality of rows and columns of pixel circuits; and
the driving module is configured to control a refresh frequency of the pixel circuits provided in the first display area to be a first refresh frequency, and control a refresh frequency of the pixel circuits provided in the second display area to be different from the first refresh frequency.

2. The display device according to claim 1, wherein the driving module is configured to, when it is determined that a picture displayed in a part of the display area comprised in the display panel changes and a picture displayed in the other part of the display area comprised in the display panel does not change, control a refresh frequency of the pixel circuits in the part of the display area to be a first refresh frequency, and control a refresh frequency of the other part of the display area to be less than the first refresh frequency; the part of the display area is an updated display area, and the other part of the display area is a non-updated display area; the updated display area is the first display area, and the non-updated display area is the second display area.

3. The display device according to claim 2, wherein
the driving module is further configured to, when at least one row of pixel circuits is provided in the updated display area, adjust a refresh frequency of the at least one row of pixel circuits in the updated display area by controlling a frequency of a first start signal and a frequency of a second start signal.

4. The display device according to claim 3, wherein the driving module comprises a first update GOA module and a second update GOA module;
the first update GOA module is configured to provide an N-type scanning signal for the at least one row of pixel circuits;
the second update GOA module is configured to provide a P-type scanning signal for the at least one row of pixel circuits;
the first update GOA module comprises multiple stages of first update GOA circuits, and the second update GOA module comprises a plurality of groups of second update GOA circuits;
a first-stage first update GOA circuit included in the first update GOA module is connected to the first start signal, and a first-stage second update GOA circuit included in the second update GOA module is connected to the second start signal.

5. The display device according to claim 3, wherein two adjacent pixel circuit groups adjacent to the at least one row of pixel circuits in the updated display area are provided in the non-updated display area; the adjacent pixel circuit group comprises at least one row of transition pixel circuits; and
the driving module is configured to control a refresh frequency of the at least one row of transition pixel circuits to be a second refresh frequency, wherein the second refresh frequency is less than the first refresh frequency, and the second refresh frequency is greater than the refresh frequency of the other part of the display area.

6. The display device according to claim 5, wherein non-adjacent pixel circuit groups other than the adjacent pixel circuit groups are further provided in the non-updated display area; the non-adjacent pixel circuit group comprises at least one row of pixel circuits; and
the driving module is configured to control a refresh frequency of pixel circuits included in the non-adjacent pixel circuit group to be a third refresh frequency; and the third refresh frequency is less than the second refresh frequency.

7. The display device according to claim 2, wherein when M rows and N columns of pixel circuits are provided in the updated display area, and N is less than a total number of columns of pixel circuits comprised in the display panel, the pixel circuit comprises a writing control circuit; M and N are positive integers;
a control end of the writing control circuit is electrically connected to a writing control line, a first end of the writing control circuit is electrically connected to a data line, and a second end of the writing control circuit is electrically connected to a data writing node; the writing control circuit is configured to control connection between the data line and the data writing node under control of a writing control signal provided by the writing control line;
the driving module is configured to control a frequency of the writing control signal connected to the control end of the writing control circuit included in pixel circuits located in a same row but in different columns in the M rows and N columns of pixel circuits, to enable a refresh frequency of the pixel circuits located in the same row but in different columns in the M rows and N columns of pixel circuits to be less than the first refresh frequency.

8. The display device according to claim 7, wherein the driving module is further configured to control the frequency of a writing control signal connected to the control end of the writing control circuit comprised in the M rows and N columns of pixel circuits to enable the refresh frequency of the M rows and N columns of pixel circuits to be the first refresh frequency.

9. A refresh driving method applied to a display device, wherein the display device comprises a display panel and a driving module; the display panel comprises a first display area, a second display area, and a plurality of rows and columns of pixel circuits; the refresh driving method comprising:
controlling, by the driving module, a refresh frequency of the pixel circuits provided in the first display area to be a first refresh frequency, and controlling, by the driving module, a refresh frequency of the pixel circuits provided in the second display area to be different from the first refresh frequency.

10. The refresh driving method according to claim 9, comprising:
when it is determined that a picture displayed in a part of the display area comprised in the display panel changes and a picture displayed in the other part of the display area comprised in the display panel does not change, controlling a refresh frequency of the pixel circuits in the part of the display area to be a first refresh frequency, and controlling a refresh frequency of the other part of the display area to be less than the first refresh frequency; wherein
the part of the display area is an updated display area, and the other part of the display area is a non-updated display area; the updated display area is the first display area, and the non-updated display area is the second display area.

11. The refresh driving method according to claim 10, comprising: when at least one row of pixel circuits is provided in the updated display area, adjusting a refresh frequency of the at least one row of pixel circuits in the updated display area by controlling a frequency of a first start signal and a frequency of a second start signal.

12. The refresh driving method according to claim 11, wherein the display panel further comprises a first update GOA module and a second update GOA module, the first update GOA module is configured to provide an N-type scanning signal for the at least one row of pixel circuits, and the second update GOA module is configured to provide a P-type scanning signal for the at least one row of pixel circuits; the first update GOA module comprises multiple stages of first update GOA circuits, and the second update GOA module comprises a plurality of groups of second update GOA circuits: a first-stage first update GOA circuit included in the first update GOA module is connected to the first start signal, and a first-stage second update GOA circuit included in the second update GOA module is connected to the second start signal.

13. The refresh driving method according to claim 11, wherein two adjacent pixel circuit groups adjacent to the at least one row of pixel circuits in the updated display area are provided in the non-updated display area; the adjacent pixel circuit group comprises at least one row of transition pixel circuits; and
the refresh driving method further comprises: controlling a refresh frequency of the at least one row of transition pixel circuits to be a second refresh frequency, wherein the second refresh frequency is less than the first refresh frequency.

14. The refresh driving method according to claim 13, wherein non-adjacent pixel circuit groups other than the adjacent pixel circuit groups are further provided in the non-updated display area; the non-adjacent pixel circuit group comprises non-adjacent pixel circuits; and
the refresh driving method further comprises: controlling a refresh frequency of the non-adjacent pixel circuit to be a third refresh frequency: wherein the third refresh frequency is less than the second refresh frequency.

15. The refresh driving method according to claim 10, wherein when M rows and N columns of pixel circuits are provided in the updated display area, and N is less than a total number of columns of pixel circuits comprised in the display panel, the pixel circuit comprises a writing control circuit; a control end of the writing control circuit is electrically connected to a writing control line, a first end of the writing control circuit is electrically connected to a data line, and a second end of the writing control circuit is electrically connected to a data writing node; the writing control circuit is configured to control connection between the data line and the data writing node under control of a writing control signal provided by the writing control line; M and N are positive integers; and the refresh driving method comprises:
controlling a frequency of the writing control signal connected to the control end of the writing control circuit included in pixel circuits located in a same row but in different columns in the M rows and N columns of pixel circuits, to enable a refresh frequency of the pixel circuits located in the same row but in different columns in the M rows and N columns of pixel circuits to be less than the first refresh frequency.

16. The refresh driving method according to claim 15, further comprising:
controlling the frequency of a writing control signal connected to the control end of the writing control circuit comprised in the M rows and N columns of pixel circuits to enable the refresh frequency of the M rows and N columns of pixel circuits to be the first refresh frequency.
